(19) United States
(12) Patent Application Publication
(10) Pub. No.: US 2020/0207174 A1
(43) Pub. Date: Jul. 2, 2020

(54) STEADY STATE ATTITUDE CONTROL USING SUSPENSION WITH VARIABLE VOLUME AIR SPRINGS

(71) Applicant: Continental Automotive Systems Inc., Auburn Hills, MI (US)

(72) Inventors: Justin Audley Ruediger, Lake Orion, MI (US); Daniel Gregory Goodrich, Cedarville, MI (US); Patrick Alan Crane, Lake Orion, MI (US)

(21) Appl. No.: 16/451,239

(22) Filed: Jun. 25, 2019

Related U.S. Application Data
(60) Provisional application No. 62/785,356, filed on Dec. 27, 2018.

(51) Int. Cl. B60G 15/08

(52) U.S. Cl. CPC B60G 15/08; B60G 2202/152; F16C 2326/05; B60G 2204/111; B60G 2204/126

(57) ABSTRACT

A vehicle air spring suspension system includes multiple air springs. Each air spring has at least one volume. A valve is fluidly arranged between at least two volumes of the at least one volume of the air springs. The valve is movable between open and closed positions in response to an input. The at least two volumes are fluidly coupled with the valve in the open position. The at least two volumes are fluidly decoupled with the valve in the closed position. At least one vehicle sensor is configured to detect a vehicle attitude condition. A controller is in communication with the valve and the at least one vehicle sensor. The controller is configured to provide the input and selectively adjust the air springs to change the vehicle attitude by raising and/or lowering at least one vehicle wheel relative to a vehicle chassis in response to the input.

This application claims priority to U.S. Provisional Application No. 62/785,356, which was filed on Dec. 27, 2018.

### BACKGROUND

Air suspensions are becoming more widely used in both on-highway and off-highway vehicle suspension systems. These suspensions enable load leveling and adjustable ride comfort features.

A conventional air spring is arranged between a vehicle body and a chassis such that the air spring applies a load to a wheel via a suspension. A typical air spring has at least one working volume or cavity that is filled with compressed air. Some air springs have multiple cavities that may be used as the working volumes. It is desirable to change the suspension characteristics for various vehicle operating conditions by changing the air spring.

### SUMMARY

In one exemplary embodiment, a vehicle air spring suspension system includes multiple air springs. Each air spring has at least one volume. A valve is fluidly arranged between at least two volumes of the at least one volume of the air springs. The valve is movable between open and closed positions in response to an input. The at least two volumes are fluidly coupled with the valve in the open position. The at least two volumes are fluidly decoupled with the valve in the closed position. At least one vehicle sensor is configured to detect a vehicle attitude condition. A controller is in communication with the valve and the at least one vehicle sensor. The controller is configured to provide the input and selectively adjust the air springs to change the vehicle attitude by raising and/or lowering at least one vehicle wheel relative to a vehicle chassis in response to the input.

In a further embodiment of any of the above, the at least two volumes are provided in one of the air springs.

In a further embodiment of any of the above, one of the at least two volumes is provided by one of the air springs. The other of the at least two volumes is provided by another of the air springs.

In a further embodiment of any of the above, the air springs are provided by a pair of front air springs and a pair of rear air springs.

In a further embodiment of any of the above, the controller provides the input under a hitching condition to lower a rear of a vehicle relative to a front of the vehicle.

In a further embodiment of any of the above, the vehicle attitude condition is at least one of a vehicle attitude, anticipated vehicle attitude, and/or a change in rate of the vehicle attitude. The controller provides the input when the vehicle attitude condition meets a predetermined threshold.

In a further embodiment of any of the above, the predetermined threshold is at least one of a vehicle speed threshold and/or vehicle attitude threshold.

In a further embodiment of any of the above, the anticipated vehicle attitude is at least one of a sharp drop and/or a steep incline.

In a further embodiment of any of the above, the vehicle attitude condition is a crowned roadway.

In a further embodiment of any of the above, the vehicle attitude condition is at least one of a departure angle and/or an approach angle.

In one exemplary embodiment, a method of controlling a vehicle air spring suspension system includes detecting a vehicle attitude condition. The method also includes determining if the vehicle attitude condition meets a predetermined threshold. The method further includes selectively coupling and/or decoupling at least two air spring volumes at the predetermined threshold. The method further includes raising and/or lowering at least one wheel relative to a vehicle chassis in response to selectively coupling and/or decoupling step.

In a further embodiment of any of the above, the method includes multiple air springs. Each air spring has at least one of the two air spring volumes. The air springs are provided by a pair of front air springs and a pair of rear air springs.

In a further embodiment of any of the above, the method includes a valve that is fluidly arranged between the at least two air spring volumes. The method also includes selectively coupling and/or decoupling step that moves the valve between open and closed positions. The at least two air spring volumes are fluidly coupled with the valve in the open position. The at least two air spring volumes are fluidly decoupled with the valve in the closed position.

In a further embodiment of any of the above, the at least two air spring volumes are provided in one of the multiple air springs.

In a further embodiment of any of the above, one of the at least two air spring volumes is provided by one of the multiple air springs. The other of the at least two air spring volumes is provided by another of the multiple air springs.

In a further embodiment of any of the above, the raising and/or lowering step is performed in response to a hitching condition to lower a rear of a vehicle relative to a front of the vehicle.

In a further embodiment of any of the above, the vehicle attitude condition is at least one of a vehicle attitude, anticipated vehicle attitude, and/or a change in rate of the vehicle attitude.

In a further embodiment of any of the above, the predetermined threshold is at least one of a vehicle speed threshold and/or vehicle attitude threshold.

In a further embodiment of any of the above, the anticipated vehicle attitude is at least one of a sharp drop and/or a steep incline.

In a further embodiment of any of the above, the vehicle attitude condition is at least one of a crowned roadway, a departure angle and/or an approach angle.

### BRIEF DESCRIPTION OF THE DRAWINGS

The disclosure can be further understood by reference to the following detailed description when considered in connection with the accompanying drawings wherein:

FIG. 1 is a schematic view of a vehicle on a side-to-side vehicle attitude.

FIG. 2 is a schematic view of the vehicle on a front-to-back vehicle attitude.

FIG. 3 is a schematic view of an air suspension system regulated by a controller in communication with a variety of sensors and inputs.

FIG. 4 is a schematic view of an air spring having multiple, fluidly connectable volumes.

FIG. 5 is a block diagram of an example method for controlling the air suspension system.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

This disclosure relates to air spring suspension system and a steady state vehicle attitude control system used to improve vehicle handling, comfort, safety, and navigation. The disclosed system is particularly useful on steep slopes and/or grades during off-highway use, although other applications are possible.

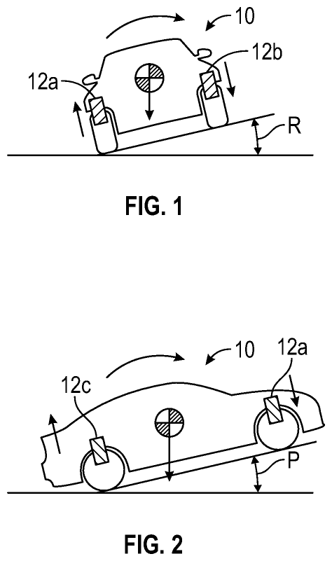

FIG. 1 illustrates a vehicle 10 on a steep slope creating a roll angle R. Air springs 12A, 12B are arranged between the vehicle body and each wheel as is known. In another example shown in FIG. 2, the vehicle 10 is arranged on a steep slope creating a pitch angle P. The wheels are supported by air springs 12A and 12C. Only a few of the air springs are illustrated in the highly schematic figures for clarity.

During vehicle operation on steep angles where the center of gravity of the vehicle has significantly shifted from a normal, level vehicle operating position, the vehicle 10 may become unstable. The disclosed system is used to raise and/or lower portions of the vehicle (straight arrows in FIGS. 1 and 2) with respect to the wheels, and thereby the ground. In this manner, the vehicle is adjusted (curved arrows in FIGS. 1 and 2) to improve stability.

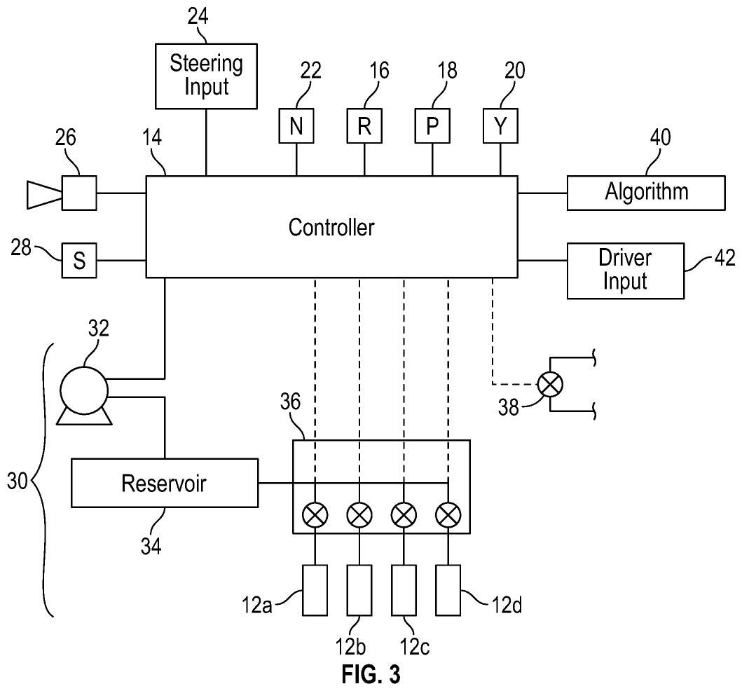

Referring to FIG. 3, a controller 14 communicates with a variety of vehicle sensors, such as roll, pitch, and yaw sensors 16, 18, 20, for example. These sensors are useful for determining vehicle attitude. A vehicle speed 22 also communicates with the controller 14. The controller 14 may also communicate with a variety of other inputs, such as a steering input 24, a camera 26, and/or other sensors such as LIDAR or radar, for example. Such sensors can be used to determine an anticipated vehicle attitude based upon vehicle speed, steering angle, navigational and other information.

A suspension system 30 is shown in a highly schematic fashion in FIG. 3. It should be understood that the system 30 may include more or fewer components, and the components may be configured differently than illustrated. The system 30 includes an air pump 32 providing pressurized air to a reservoir 34. The pressurized air is selectively provided to the air springs 12A, 12B, 12C, 12D via one or more valves in a valve block 36.

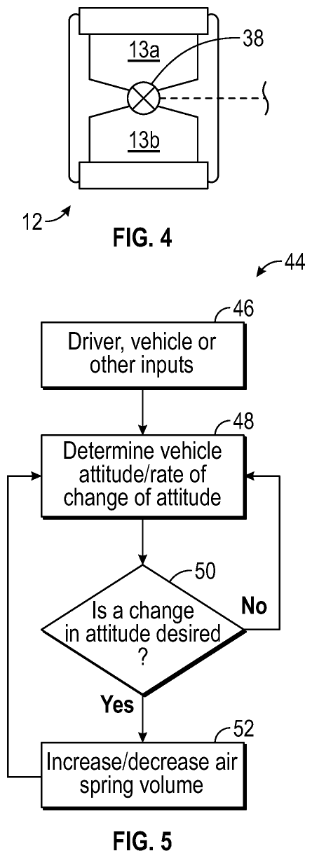

The system 30 may also include additional valves 38 that are used instead of or in addition one more of the valves in the valve block 36 to selectively fluidly interconnect two or more of the air spring volumes to one another and/or selectively fluidly connect multiple volumes 13A, 13B within an air spring 12, as schematically illustrated in FIG. 4.

A driver input 42 may be used to manually select between various driving conditions, such as comfort or sport, or place the vehicle into an off-highway mode. In such a mode, the controller 14 may automatically level or reposition the vehicle for improved stability in response to calculations by an algorithm 40 based upon the various inputs to the controller 14. The various modes may have different vehicle attitude threshold from one another and upon which the valve(s) are controlled to couple and/or decouple the air spring volumes.

Referring to FIG. 5, a method 44 includes detecting driver, vehicle, or other inputs, as indicated at block 46. The vehicle attitude and/or rate of change of the attitude is determined, as indicated at block 48. If the attitude or rate of change is undesired, as determined at block 50, the spring volume of one or more air springs can be increased or decreased, as indicated at block 52 to reposition the vehicle with respect to the steep slope or grade.

In one example, when the vehicle is traveling at a relatively low speed, for example, less than 3 km/hr, and a slope or grade of 30% is exceeded, the controller may begin to automatically adjust the air springs to tilt or reposition the vehicle 10 to a more stable orientation with respect to the ground or roadway. If desired, the system may anticipate a needed vehicle reorientation in response to detecting terrain that would necessitate such an adjustment, for example, a sharp drop or a steep incline at a vehicle corner. In this manner, each wheel may be independently raised or lowered, as needed, to achieve desired vehicle orientation and stability.

The above-described system may also be used to change the vehicle attitude on crowned roadways. Adjusting the air spring heights in these conditions may mitigate vehicle yaw tendencies requiring steering wheel offsets so that straight-line driving may be maintained. Obstacles can retard and limit vehicle navigation. Approach and departure angles can be maximized using the disclosed system by controlling vehicle attitude to aid obstacle navigation.

Trailer hitching can be difficult or impossible based on relative vehicle and trailer hitch heights. Vehicle attitude also can be controlled using the disclosed system to lower a vehicle trailer hitch and aid in hitching.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A vehicle air spring suspension system comprising:
multiple air springs, each air spring having at least one volume;
a valve fluidly arranged between at least two volumes of the at least one volume of the air springs, the valve movable between open and closed positions in response to an input, the at least two volumes fluidly coupled with the valve in the open position, and the at least two volumes fluidly decoupled with the valve in the closed position;
at least one vehicle sensor configured to detect a vehicle attitude condition;
a controller in communication with the valve and the at least one vehicle sensor, the controller configured to provide the input and selectively adjust the air springs to change the vehicle attitude by raising and/or lowering at least one vehicle wheel relative to a vehicle chassis in response to the input.

2. The system of claim 1, wherein the at least two volumes are provided in one of the air springs.

3. The system of claim 1, wherein one of the at least two volumes is provided by one of the air springs, and the other of the at least two volumes is provided by another of the air springs.

4. The system of claim 1, wherein the air springs are provided by a pair of front air springs and a pair of rear air springs.

5. The system of claim 4, wherein the controller provides the input under a hitching condition to lower a rear of a vehicle relative to a front of the vehicle.

6. The system of claim 1, wherein the vehicle attitude condition is at least one of a vehicle attitude, anticipated vehicle attitude, and/or a change in rate of the vehicle attitude, wherein the controller provides the input when the vehicle attitude condition meets a predetermined threshold.

7. The system of claim 6, wherein the predetermined threshold is at least one of a vehicle speed threshold and/or vehicle attitude threshold.

8. The system of claim 6, wherein the anticipated vehicle attitude is at least one of a sharp drop and/or a steep incline.

9. The system of claim 6, wherein the vehicle attitude condition is a crowned roadway.

10. The system of claim 6, wherein the vehicle attitude condition is at least one of a departure angle and/or an approach angle.

11. A method of controlling a vehicle air spring suspension system comprising:
detecting a vehicle attitude condition;
determining if the vehicle attitude condition meets a predetermined threshold; and
selectively coupling and/or decoupling at least two air spring volumes at the predetermined threshold; and
raising and/or lowering at least one wheel relative to a vehicle chassis in response to selectively coupling and/or decoupling step.

12. The method of claim 11, comprising multiple air springs, each air spring having at least one of the two air spring volumes, wherein the air springs are provided by a pair of front air springs and a pair of rear air springs.

13. The method of claim 12, comprising a valve fluidly arranged between the at least two air spring volumes, the selectively coupling and/or decoupling step moves the valve between open and closed positions, the at least two air spring volumes fluidly coupled with the valve in the open position, and the at least two air spring volumes fluidly decoupled with the valve in the closed position.

14. The method of claim 13, wherein the at least two air spring volumes are provided in one of the multiple air springs.

15. The method of claim 13, wherein one of the at least two air spring volumes is provided by one of the multiple air springs, and the other of the at least two air spring volumes is provided by another of the multiple air springs.

16. The method of claim 11, wherein the raising and/or lowering step is performed in response to a hitching condition to lower a rear of a vehicle relative to a front of the vehicle.

17. The method of claim 11, wherein the vehicle attitude condition is at least one of a vehicle attitude, anticipated vehicle attitude, and/or a change in rate of the vehicle attitude.

18. The method of claim 17, wherein the predetermined threshold is at least one of a vehicle speed threshold and/or vehicle attitude threshold.

19. The method of claim 17, wherein the anticipated vehicle attitude is at least one of a sharp drop and/or a steep incline.

20. The method of claim 17, wherein the vehicle attitude condition is at least one of a crowned roadway, a departure angle and/or an approach angle.
